(19) United States
(12) Patent Application Publication
(10) Pub. No.: US 2017/0154268 A1
(43) Pub. Date: Jun. 1, 2017

(54) AN AUTOMATIC STATISTICAL PROCESSING TOOL

(71) Applicant: Ephraim GOLDIN, Tel Aviv (IL)

(72) Inventor: Ephraim GOLDIN, Tel Aviv (IL)

(73) Assignee: GSTAT ANALYTICS SOLUTIONS LTD., Tel Aviv (IL)

(21) Appl. No.: 15/308,665

(22) PCT Filed: Apr. 30, 2015
(86) PCT No.: PCT/IL2015/050454

§ 371 Date: Nov. 3, 2016

(30) Foreign Application Priority Data
May 4, 2014 (IL) 232444

(51) Int. Cl. G06N 5/04; G06Q 30/02; G06F 17/18

(52) U.S. Cl. CPC G06N 5/04; G06F 17/18; G06Q 30/0202; G06Q 30/0239; H04L 67/42

(57) ABSTRACT

A computer-readable medium comprising computer readable code for predicting customer behavior regarding to at least one offer, the computer-readable medium comprising: a computer-readable code adapted to, obtain a set of population data extracted from at least one database of population group and target building potential list; a computer-readable code adapted to, create a sampling process said sampling process samples said population data set and creates sample of said potential list; a computer-readable code adapted to, automatically create and execute a segmentation model to partitioned said sample from said population data set to segments; a computer-readable code adapted to, automatically generate sub-offers for each of said segments; a computer-readable code adapted to, automatically create and execute statistical behavior model for each of said sub-offer; a computer-readable code adapted to, combine results and statistical formulas of said sub-offer behavior models; a computer-readable code adapted to, automatically create a model for parent-offer obtained from the combine results and formulas of said behavior models wherein, said parent model provides score prediction and statistical measures for each customer in the sample according to the model of said sub_offer of the segment that said customer belongs to; and a computer-readable code adapted to, automatically create a scoring process for all of said data population set, whereby, after all customers are scored, all scores are gathered into one overall scores list which is sorted by a score and ranked module by percentiles.

### FIELD OF THE INVENTION

The present invention relates to analysis of computer databases and, more particularly, to automatic data mining.

### BACKGROUND OF THE INVENTION

Data Mining is a process designed to explore data, usually large amounts of data—typically business or market related in search of consistent patterns and/or systematic relationships between variables, and then to validate the findings by applying the detected patterns to new subsets of data. The ultimate goal of data mining is prediction—and predictive data mining (also known as predictive analytics), is the most common type of data mining and one that has the most direct business applications. Predictive modeling is specifically directed towards extracting data patterns that have predictive value.

Data mining uses statistical principles to discover patterns in a data set, helping make intelligent decisions about complex problems. By applying the data mining algorithms in Analysis Services to the data, trends can be forecast, identify patterns, create rules and recommendations, analyze the sequence of events in complex data sets, and gain new insights.

In various areas, including marketing, predictive modeling is often used for forecasting a behavior for example of predicting customer behavior. The main purpose of the models is the identification of behavioral characteristics and the historical actions of the subjects for example the customers when carried out a certain action for example purchasing of a particular product, abandoning a company that they worked with, execution of a particular services, etc. Based on the identification of the behavioral characteristics and historical actions the models can predict the chance of a certain operation or action and the scope of the action among a group of other subjects or customers. These operations or actions are typically used as the basis for targeting an effective communication on a particular customer and can be also used for improving business operations.

Accordingly, there are many statistical models that can predict customer behavior. A well known example is a decision tree model which allows segmentation of a population sample by predetermine indicators that were characterized from the population sample and providing a grade for each segment according to the chances of the population that the segmentation represents to perform a requested operation.

Another prediction model example is the prediction using logistic regression and variable selection models. The variables are selected based on a sample from the population, and accordingly a complex formula for prediction is generated and executed on the entire population allows a scoring relative to each member of the group according to a probability between 0 to 1 that the customer will perform the action or requested operation.

Many times model users are not satisfied with running only one prediction and scoring model, and thus dividing the population according to some segmentation rule or criteria. Then, build a separate model for each one of the segments and for each action that is to be predicting in order to get more accurate prediction in each segment. Such steps are usually very complex. First, because it requires a lot of work over, instead of developing a one model for action prediction there is needed to develop many models to predict action for each segment. Secondly, because the models generates results that are not necessarily united. Each one in the general population gets a score that is suited to its segment that was pre-generated from a certain population sample and thus there isn't a uniform score for the entire population.

Often, users are interested in the prediction of number of different actions such as different products, or conditions in a particular product. Building statistical models to predict the chance occurrence for every action or condition and for different segments which provide better prediction compared to building statistical models to predict chance of occurrence of each action on the entire population, is a time-consuming process.

CN101620691 discloses an automatic data mining platform in the telecommunications industry, which includes a data preparation module, a service model and mathematical model mapping module, an automatic modeling and evaluating module, and a model releasing and deploying module. The data preparation module extracts high-quality data which can be directly used for modeling from one or more data sources, and builds an analysis type data set and a data mart. The service model and the mathematical model mapping module select corresponding mathematical models according to the demands of service models to be built. The automatic modeling and evaluating module builds service models according to the high-quality data extracted by the data preparation module and the corresponding mathematical models, and selects the optimal service model after evaluating the performance of the built models; and the model releasing and deploying module releases and deploys the service model.

U.S. Pat. No. 6,542,894 describe a method executed on a computer for modeling expected behavior. The method includes scoring records of a dataset that is segmented into a plurality of data segments using a plurality of models and converting scores of the records into probability estimates. Two of the techniques described for converting scores into probability estimates are a technique that transforms scores into the probabilities estimates based on an equation and a binning technique that establishes a plurality of bins and maps records based on a score for the record to one of the plurality of bins.

US 20090030864 discloses a computerized method for automatically building segmentation-based predictive models that substantially improves upon the modeling capabilities of decision trees and related technologies, and that automatically produces models. According to the method segmentation and multivariate statistical modeling within each segment is performed simultaneously. Segments are constructed so as to maximize the accuracies of the predictive models within each segment. Simultaneously, the multivariate statistical models within each segment are refined so as to maximize their respective predictive accuracies.

U.S. Pat. No. 7,720,782 disclose predictive models which are developed automatically for a plurality of modeling variables. The plurality of modeling variables is transformed, based on a transformation rule. A clustering of the transformed modeling variables is performed to create variable clusters. A set of variables is selected from the variable clusters based on a selection rule. A regression of the set of variables is performed to determine prediction variables. The prediction variables are utilized in developing a predictive model. The development of the predictive model may include modification of the predictive model, review of the plurality of transformations, and validation of the predictive model. Predictive models are developed automatically for a plurality of modeling variables. The plurality of modeling variables is transformed, based on a transformation rule. A clustering of the transformed modeling variables is performed to create variable clusters. A set of variables is selected from the variable clusters based on a selection rule. A regression of the set of variables is performed to determine prediction variables. The prediction variables are utilized in developing a predictive model. The development of the predictive model may include modification of the predictive model, review of the plurality of transformations, and validation of the predictive model.

One object of the present invention is to provide an automatic system and/or process that receive in its inputs a predefinition of types of actions for example regarding products, loans, policy, abandonment event, telephone service center, payments and etc. In addition the system receives another input, data about a define population as it appeared in the database of a company or any other entity for each of the action types. The system will automatically output a prediction score between 0 to 1 regarding to each action and regarding to each individual in the defined population. The score between 0 to 1 predicts the chance of the individual in the defined population to execute each action that was defined in the system and/or process inputs.

Another object of the present invention is to provide a whole business solution for personalized cross/up-sell/retention/win-back recommendations as opposed to a data mining R&D environment that data mining software vendors provide and require professional services of statisticians and BI experts for data management and modeling.

Another object of the present invention is, to dramatically decrease the time required for development and deployment of cross/up-sell models, while still getting the same lifts like manually developed models by statisticians, and even higher lifts thanks to developing models per each offer, by different segments.

Another object of the present invention is to update the models more frequently—adjusting the model to a changing business environment.

Another object of the present invention is to provide a solution that requires no statistical-analytical know-how whatsoever. The present invention will automatically perform all complex ETL and statistical processes.

ETL refers to a process in database usage and especially in data warehousing that, extracts data from outside sources, transforms it to fit operational needs, which can include quality levels and loads it into the end target (database, more specifically, operational data store, data mart, or data warehouse). ETL systems are commonly used to integrate data from multiple applications, typically developed and supported by different vendors or hosted on separate computer hardware. The disparate systems containing the original data are frequently managed and operated by different employees. For example a cost accounting system may combine data from payroll, sales and purchasing.

### SUMMARY OF THE INVENTION

The present invention relates to analysis of computer databases and, more particularly, to automatic data mining.

In accordance with an embodiment of the present invention there is provided a computer-readable medium comprising computer readable code for predicting customer behavior regarding to at least one offer, the computer-readable medium including, a computer-readable code adapted to, obtain a set of population data extracted from at least one database of population group and target building potential list. The computer-readable medium further includes a computer-readable code adapted to, create a sampling process, the sampling process samples the population data set and creates sample of the potential list. The computer-readable medium further includes a computer-readable code adapted to, automatically create and execute a segmentation model to find segments in the sample of the population data. The computer-readable medium further includes a computer-readable code adapted to, automatically generate sub-offers for each of the segments. The computer-readable medium further includes a computer-readable code adapted to, automatically create and execute statistical behavior model for each of the sub-offer. The computer-readable medium further includes a computer-readable code adapted to, combine results and formulas of the sub-offer behavior models. The computer-readable medium further includes a computer-readable code adapted to, create a model for parent-offer obtained from the combine results and formulas of the behavior models wherein, the parent model provides score prediction and statistical measures for each customer in the sample according to the model of the sub_offer of the segment that the customer belongs to. The computer-readable code further adapted to, automatically create a scoring process for all of said data population set, whereby, after all customers are scored, all scores are gathered into one overall scores list which is sorted by a score and ranked module by percentiles.

### BRIEF DESCRIPTION OF THE DRAWINGS

The invention may be understood upon reading of the following detailed description of non-limiting exemplary embodiments thereof, with reference to the following drawings, in which:

FIG. 1 is a block diagram illustrating a client/server system adapted to implement an embodiment of the present invention;

FIG. 2 is a block diagram illustrating a client and/or server or any other data mining processing system;

FIG. 3 is a flowchart that depicts a prediction model in accordance with one embodiment of the present invention;

FIG. 4 is a flowchart that depicts model creation of sub-offer;

FIG. 5 is a flowchart that depicts model creation of parent offer; and

FIG. 6 is a flowchart depicts a propensity prediction model and amount/income prediction model in accordance with one embodiment of the present invention.

FIG. 7 is a flowchart depicts the two main processes for modeling scoring;

FIG. 8 is a flowchart depicts the process for scoring for the propensity prediction and for amount/income prediction.

The following detailed description of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION OF EMBODIMENTS OF THE INVENTION

In the following description, details are set forth to provide an understanding of the invention. In some instances, certain software, circuits, structures and methods have not been described or shown in detail in order not to obscure the invention. The term “data processing system” is used herein to refer to any machine for processing data, including the client/server computer systems and network arrangements described herein. The present invention may be implemented in any computer programming language provided that the operating system of the data processing system provides the facilities that may support the requirements of the present invention. Any limitations presented would be a result of a particular type of operating system or computer programming language and would not be a limitation of the present invention. The invention may also be implemented by hardware.

Referring to FIG. 1 is a block diagram illustrating a client/server system 50 adapted to implement an embodiment of the invention. The client/server system 50 includes a server 52, which may be maintained by a service provider, communicating with one or more clients 54, 55 over a network 56, such as the Internet. According to one embodiment of the present invention, the server 52 includes a database system, not shown, for storing and accessing data sets of population such as but not limited to clients. The database system may include database management (DBMS). The data base system and the DBMS may be stored in the memory of server 52 or stored in a distributed data processing system, not shown. The standard database query language for dealing with relational database implemented by most DBMSs is the Structured Query Language (SQL).

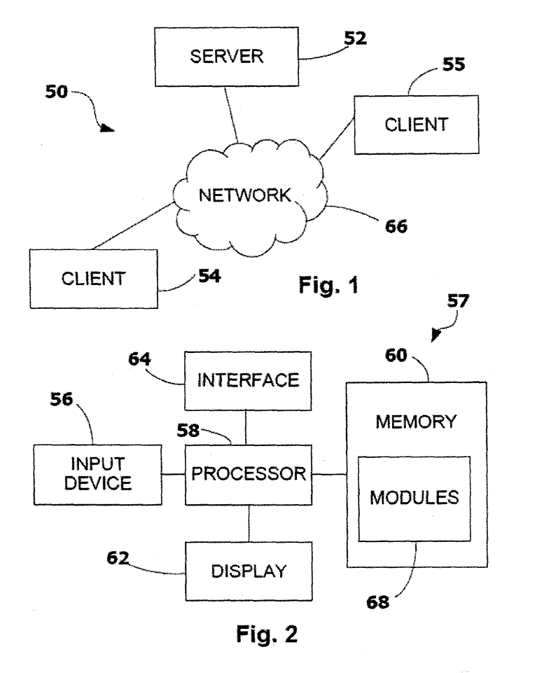

FIG. 2 is a block diagram illustrating a data processing system which could be a computer system 57 a client 54, 55 and/or server system 52 adapted to implement an embodiment of the invention. Typically, each data processing system includes an input device 56 such as but not limited to mouse, keyboard. The processing system further includes a processor 58, memory 60, a display 62, and an interface device 64. The memory 60 may include RAM, ROM, databases, or disk devices. The display 62 may include a computer screen, a hardcopy producing output device such as a printer. And, the interface device 64 may include a connection or interface to a network 66 such as the Internet. Thus, the data processing system 57, 54, 52, 55 may be linked to other data processing systems (e.g., by a network 66. The data processing system 57 and/or 54, 55 and/or 52 has stored therein data representing sequences of instructions which when executed causes the method described herein to be performed. Of course, the data processing system 57, 54, 52 and 55 may contain additional software and hardware a description of which is not necessary for understanding the invention.

Thus, the data processing system 57, 52, 55 and 54 includes computer executable programmed instructions for directing the system 57, 52, 55 and 54 to implement the embodiments of the present invention. The programmed instructions may be embodied in one or more hardware or software modules 68 that may resident in the memory 60 of the data processing system 57, 52, 50 and 54.

The term “module” described in the specification imply a unit of processing a predetermined function or operation and can be implemented by hardware or software or a combination of hardware and software.

Alternatively, the programmed instructions may be embodied on a computer readable medium (such as a CD disk and mobile hard drive) which may be used for transporting the programmed instructions to the memory 60 of the data processing system 57, 52 and 54. Alternatively, the programmed instructions may be embedded in a computer-readable, or any other suitable medium that is uploaded to a network 66 by a vendor or supplier of the programmed instructions and this medium may be downloaded through the interface 64 to the data processing system 57, 52 and 54 from the network 66 by end users or potential buyers.

In accordance with some embodiments of the present invention there is provided an automated system which may includes client/server system 50 or processing system 57 that adapted to receive preset types of actions (for example products, loans, policies, repayments, events abandonment, requests service center, etc.). The system further adapted to receive a specific population groups and all its data for each type of the action as it appears in the database which could be stored in server 52 or memory 60.

The system in accordance with one embodiment of the present invention samples a specific population group, and on the sample executes a module of a statistical model which divides the group into segments for example by using a Decision Tree statistical model. The model runs automatically and for each of the actions. In the automatic multi segment modeling the method and system of the present invention apply a process module that automatically creates the segment where for each one of the segments one or more models are created. The system performs variable selection and creating predictive formula for each action and for each of the segments. This predictions, allows providing a predictive score from 0 to 1 for each individual in the population and regarding to each action based on a formula selected to its corresponding segment and relatively to the entire population. The system performs these steps automatically for all the actions and their prediction.

Once the types of actions are selected and the population group is selected, the system operates alone when the output of the system can be displayed on display 62 provides a series of predictive values for each individual in the population representing his chance to perform any of the actions defined at the beginning of the system operation.

A typical decision tree model is the model of computation or communication in which an algorithm or communication process is considered to be basically a decision tree, i.e., a sequence of branching operations based on comparisons of some quantities, the comparisons being assigned the unit computational cost. The branching operations are called “tests” or “queries”. In this setting the algorithm in question may be viewed as a computation of a Boolean function where the input is a series of queries and the output is the final decision. Every query is dependent on previous queries. Several variants of decision tree models may be considered, depending on the complexity of the operations allowed in the computation of a single comparison and the way of branching.

Decision tree learning uses a decision tree as a predictive model which maps observations about an item to conclusions about the item's target value. It is one of the predictive modeling approaches used in statistics and data mining More descriptive names for such tree models are classification trees or regression trees. In these tree structures, leaves represent class labels or segments in the population sample and branches represent conjunctions of features that lead to those class labels.

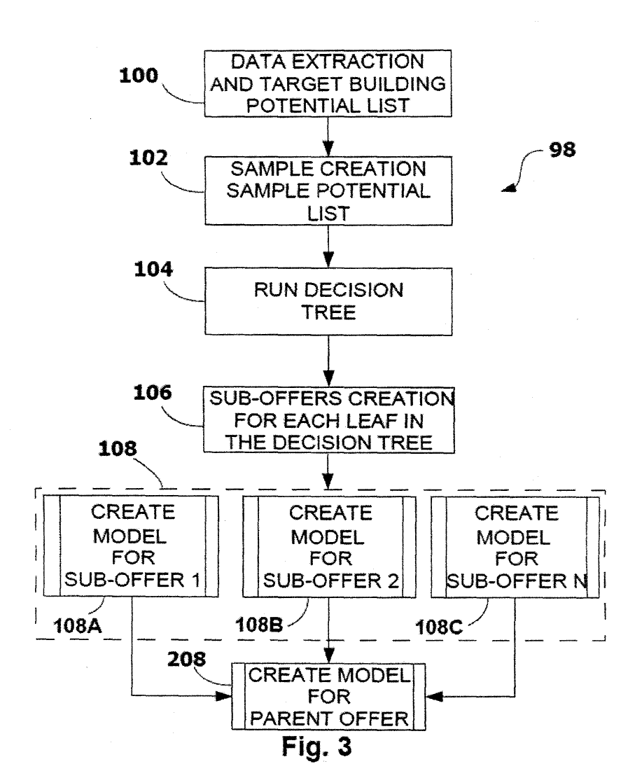

Referring first to FIG. 3, a flow chart 98 depicts a prediction model that calculates the propensity for a product or an activity in accordance with one embodiment of the present invention. In step 100 one or more data set are extracted and target building potential list is created. According to the activity chosen and the target population the population is extracted from the database and the target is built. The first step of model building is to extract the data according to the conditions defined in the offer for example in the product and to the configuration parameters. An offer may refer also to the propensity of a customer to a product or an activity. Model building is the process of developing a probabilistic model that best describes the relationship between a dependent and independent variables. According to the present invention there is provided an engine that based on the conditions defined, creates the SQL syntax for the data extraction.

In the same process of the data extraction the engine builds the target indicator to be used in the modeling process according to the activity for example regarding to a certain product chosen in the offer definition. In this step the engine creates the syntax to extract the data and build the potential list with the target variables to be used in the next steps of the modeling process.

There are different options that can be used and influence the syntax building, for example:

History mode—the system can model both if the customer has a product or if the customer bought the product in the predefined period (month, week, etc.)

RFM Mode—automatically decide if the offer is Cross-sell or Up-sell according to the previous purchases of the product (or higher level).

RFM is referred to a method used for analyzing customer value. It is commonly used in database marketing and direct marketing and has received particular attention in retail and professional services industries. RFM stands for Recency—How recently did the customer purchase? Frequency—How often do they purchase? Monetary Value—How much do they spend?

The data extraction process will be created also for the scoring step. In step 102 sampling population data, in order to avoid long time processes during the modeling step a sampled data is used instead of all the population data. In accordance with some embodiments of the present invention the sampling process step creates three samples, an In-sample—to be used for modeling, Out-of-sample—to be used for validation on the same periods used in modeling and Out-of-time-sample—to be used for validation on the last period of the customer profile, period that it is not used in modeling. The data points used to build the model constitute in-sample-data where as all the new data points not belonging to the training sample constitute out-of-sampling-data.

Since sometime the target variable is very rare, preferably more observations in the in-sample population are left than to have a validation set.

Since usually the target variable is rare the oversampling method is used that includes in the sample all the learning observations and a sample of the potential observation. Below, the following parameters are examples according to some embodiments of the present invention for each of the samples which are configurable:

1) Number of observations in the sample for example the parameter N

2) Minimum of learning observations (the “1”s)

3) Minimum of potential population (the “0”s)

4) Maximum percentage of learning observation (usually 50%).

5) In-sample percentage the percentage of the in-sample out of the total of the in-sample and out-of-sample population (usually 70%).

The logic of building the sample is as follows:

1) If there are at least two periods in the customer profile the out-of-time sample can be built.

2) From the potential list which includes the population of the model with the target variable, the counts of learning and potential observation for the last period is calculate for out-of-time and the other periods, for in-sample and out-of-sample.

3) According to the results of the counting we can decide if we have enough observation to build the three samples.

4) If there is enough observations the samples will be built as describe below:
4.1) In-sample—a sample of the learning population excluding the last period up to 50% of the sample size (N).
4.2) Out-of-sample—a sample of the learning population excluding the last period up to 50% of the sample size (N). This sample is built after the in-sample so that there are no observations in common.
4.3) Out-of-time-sample—a sample of the learning population from the last period up to 50% of the sample size (N).

5) If there is not enough observation for the out-of-time, the samples will be built in this way:
5.1) In-sample—a sample of the learning population including also the last period up to 50% (Perc1) of the sample size (N).
5.2) Out-of-sample—a sample of the learning population including also the last period up to 50% (Perc1) of the sample size (N).

This sample is built after the in-sample so that there are no observations in common.

6) If there is not enough observation for the in-sample the samples will be built in this way:

Use all the periods and check if there are enough for the in and out of samples.

In step 104 the system and method of the present invention build a decision tree model. On the sample data a decision tree is built with the variables from the customer profile that are available in the database for this step. The main parameters used in the decision tree are the following: the minimum number of observations in any terminal leaf, the maximum number of leafs and the complexity parameter. Any split that does not decrease the overall lack of fit by a factor of Mallows's Cp statistic is not attempted. The result of the decision tree is the creation of segments to be used further. Other suitable statistical models known in the art for creating segments from the sampled population may be used in this step.

In step 106 sub-offer creation for each leaf in the decision tree (or each value in the segment) an offer is created (sub-offers of the parent-offer).

Data mining in customer relationship management applications can contribute significantly. For example rather than randomly contacting a prospect or customer through a call center or sending mail, a company can concentrate its efforts on prospects that are predicted to have a high likelihood of responding to an offer. With sub-offer creation the data processing system may predict to which channel and to which sub-offer an individual is most likely to respond (across all potential offers).

In step 108 a statistical model is built for each sub-offer. For each leaf in the decision tree (or each value in the segment) a models 108A, 108B, 108C (for example, creating 3 sub-offers) or an alternative predictions are created. For each model and for the parent-offer the comparison of the accuracy statistics and graphs are created.

In step 208 a model for the parent-offer is created. For each sub-offer model and for the parent-offer model the comparison of the accuracy statistics and graphs are created. For the parent-offer model the statistics and graphs of the combination of the sub-offers is also calculated and created. On the same sample of the parent-offer the prediction is calculated using for each customer the formula from the model of the segment the customer belongs to. This allows to compare the two predictions and to calculate the statistics and graphs on the same sample.

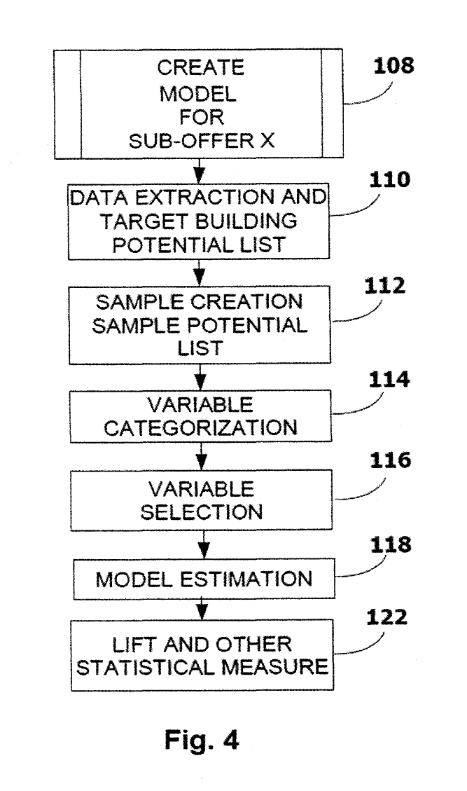

Referring now also to FIG. 4 the creation of sub-offer models in accordance with embodiment of the present invention includes steps 110-122 as describe below. In step 110, data set is extracted regarding a segment of a sub-offer for example a segment of sub-offer 108A the segment is now extracted from the database from the entire population or population group. A potential list of the segment population and target variables are built. The first step of model building is to extract the data according to the conditions defined in the sub-offer for example in the product and to the configuration parameters. In step 112 sampling the segment population data, in order to avoid long time processes during the modeling step a sampled data is used instead of all the population data. In accordance with some embodiments of the present invention the sampling process step creates three samples, an In-sample—to be used for modeling, Out-of-sample—to be used for validation on the same periods used in modeling and Out-of-time-sample—to be used for validation on the last period of the customer profile, period that it is not used in modeling. In step 114 a variable categorization is built for statistical model prediction. The variable categorization (automatic categorization of discrete variables and automatic categorization of continuous variables) will describe later below in detail. In step 116 a variable selection is built. The variable selection process will described later below in detail. In step 118, model estimation is built. The modeling process and model estimation will describe later below with more detail. In step 122 lift charts and other statistical measure are built. Detail description about the automatic lift charts and statistical measures are described later below.

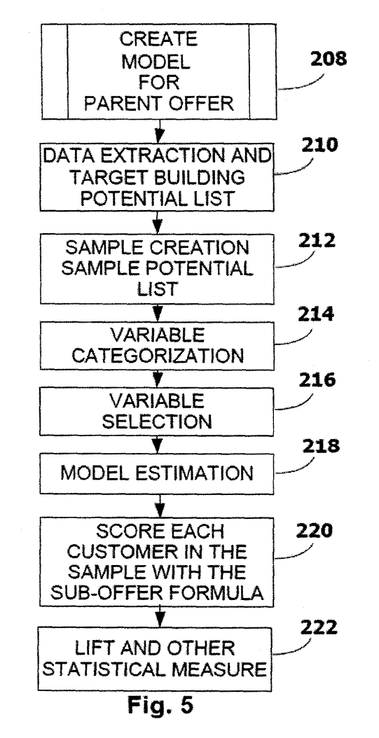

Referring now to FIG. 5 is a flow chart that depicts model creation of parent offer 208. In step 210, one or more data set are extracted and target building potential list is created. According to the activity chosen and the target population the population is extracted from the database and the target is built. In step 212 sampling the segment population data, in order to avoid long time processes during the modeling step a sampled data is used instead of all the population data. In accordance with some embodiments of the present invention the sampling process step creates three samples, an In-sample—to be used for modeling, Out-of-sample—to be used for validation on the same periods used in modeling and Out-of-time-sample—to be used for validation on the last period of the customer profile, period that it is not used in modeling. In step 214 a variable categorization is built for statistical model prediction. The variable categorization (automatic categorization of discrete variables and automatic categorization of continuous variables) will describe later below in detail. In step 216 a variable selection is built. The variable selection process will described later below in detail. In step 218, model estimation is built. The modeling process and model estimation will describe later below with more detail. In step 220 each customer in the sample with the sub-offer formula gets score. Detail description about the automatic scoring process will describe in more detail later below. In step 222 lift charts and other statistical measure are built. In a Multi-Segment Offer the comparison of the accuracy statistics and graphs for the parent offer and for the combination of the sub-offers is added. On the same sample of the parent offer the prediction is calculate using for each customer the formula from the model of the segment the customer belongs to. This allows to compare the two predictions and to calculate the statistics and graphs on the same sample.

Detail description about the automatic lift charts and statistical measures are described later below.

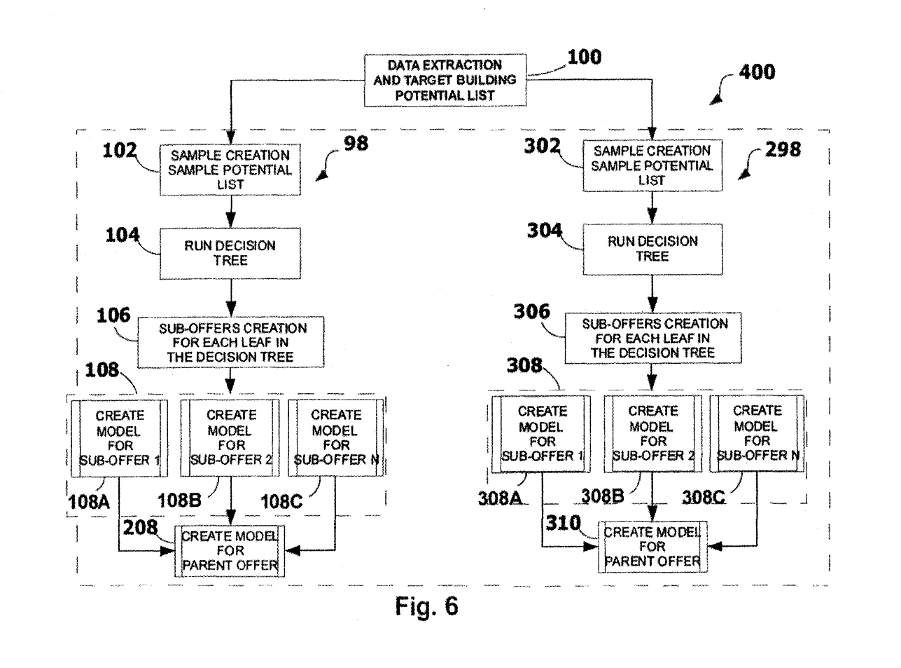

Referring now to FIG. 6 the system and method of the present invention calculates in addition to the propensity for a product or an activity 98 also the estimation model 298 of the amount of the product purchase and/or the income from the sale of the product. System and method in accordance with some embodiments of the present invention performs automatically the steps of the propensity for a product or an activity 98, and the steps of the model for estimation of the amount of the product purchase and/or the income from the sale of the product 298.

Data extraction and Target building, this process, 100 is based on the Data extraction and Target Building at step 100 used for propensity model 98 as described above. For the amount and the income models 298 the customers with the target variable equal to 1 will be the potential population for the model.

Referring to step 302 the sampling process of the amount and the income models 298, this process is different than the sampling process for the propensity model 102. The sampling process creates three samples: The first sample is the In-sample—to be used for modeling. The second sample is the Out-of-sample—to be used for validation on the same periods used in modeling. The third sample is the out-of-time sample—to be used for validation on the last period of the customer profile, period that it is not used in modeling. Since sometimes the target variable is very rare than it would be preferable to leave more observations in the in-sample population than to have a validation set. For each of the samples are the following parameters (configurable):

a) Number of observations in the sample—N
b) Minimum number of observations

The logic of building the sample is as follows:

If there are at least two periods in the customer profile we can build the out of time sample.

From the potential list (the population of the model with the target variable) we calculate the counts of the observations for the last period (for out-of-time) and the other periods (for in-sample and out-of-sample).

According to the results of the counting we can decide if we have enough observation to build the three samples.

If there is enough observation the samples will be built.

If there are not enough observation for the out-of-time, the in sample and out of sample will be built.

If there is not enough observation for the in sample and out of sample only the in sample will be created.

If there are still not enough observations also for the in sample there will be not a model but only an alternative prediction.

In step Automatic categorization of continuous variables

This process is the same as for the propensity model

Automatic categorization of discrete variables

This process is similar to the process used for the propensity model. The algorithm used for categorization groups values of the variable with similar target means.

The steps 102, 104, 106 that were described in propensity model 98 is similar to steps 302, 304, 306. The steps for creation of model for sub-offer 1 . . . N 308 is similar to the steps for creation of model for sub-offer 1 . . . N 108 parent model 310, however with some differences. The automatic categorization of continuous variables that was described regarding to variables selection process that was described above in step 114 and step 214 is similar to models 308 and model 310.

The automatic categorization of discrete variables that was described regarding to variables selection process in step 114 and step 214 is similar also in model 308. The algorithm used for categorization groups values of the variable with similar target means. The variable selection algorithm that was described in steps 116 and 216 is very similar to the algorithm used in models 308 and model 310 of propensity model 298. The difference is that since the dependent variable is a continuous variable it is categorized before the one-dimensional correlation is calculated. The modeling process is very similar to the propensity modeling process. The difference is that since the amount and the income target variables are continuous variables the model is based on the Linear Regression and uses the GLM procedure with the options of normal family and identity link function. The outputs of the Linear Regression modeling process are:

a) Overall statistics on the model (significance, deviance, AIC, R square).
b) Parameter estimation.

The scoring process is very similar to the scoring process for the propensity model. The only difference is that the population extraction contains all the customers to be scored according to the conditions of the scoring population used in the propensity model.

Variables Selection Process

The variables selection process consists of three steps:

a. Examination of the one-dimensional correlation of each variable with the dependent variable by calculating the Pearson's chi-squared test.

b. Examination of multidimensional correlation between the explanatory variables to avoid Multicollinearity.

c. Top N significant uncorrelated variables are chosen to the model.

Multicollinearity is a statistical phenomenon in which two or more predictor variables in a multiple regression model are highly correlated, meaning that one can be linearly predicted from the others with a non-trivial degree of accuracy. In this situation the coefficient estimates may change erratically in response to small changes in the model or the data. Multicollinearity does not reduce the predictive power or reliability of the model as a whole, at least within the sample data themselves; it only affects calculations regarding individual predictors. That is, a multiple regression model with correlated predictors can indicate how well the entire bundle of predictors predicts the outcome variable, but it may not give valid results about any individual predictor, or about which predictors are redundant with respect to others.

First Step: Test of Independence Between the Target Variable and the Explanatory Variable

The purpose of this step is to select variables that have a significant explanation with the target but not too much (and therefore be part of the target variable to be explained for example).

Calculation of the Pearson's chi-squared test.

The value of the test-statistic is

$${X}^{2} = {\sum }_{i = 1}^{n} \frac{{( {O}_{i} - {E}_{i} )}^{2}}{{E}_{i}}$$

where

X²=Pearson's cumulative test statistic, which asymptotically approaches a χ² distribution.

Oᵢ=an observed frequency;

Eᵢ=an expected (theoretical) frequency, asserted by the null hypothesis;

n=the number of cells in the table.

The chi-squared statistic can then be used to calculate a p-value by comparing the value of the statistic to a chi-squared distribution. The number of degrees of freedom is equal to the number of cells n, minus the reduction in degrees of freedom, p

In this case, an “observation” consists of the values of two outcomes and the null hypothesis is that the occurrence of these outcomes is statistically independent. Each observation is allocated to one cell of a two-dimensional array of cells (called a table) according to the values of the two outcomes. If there are r rows and c columns in the table, the “theoretical frequency” for a cell, given the hypothesis of independence, is

$${E}_{i , j} = \frac{( {\sum }_{{n}_{c} = 1}^{c} {O}_{i , {n}_{c}} ) \cdot ( {\sum }_{{n}_{r} = 1}^{r} {O}_{{n}_{r} , j} )}{N} ,$$

where N is the total sample size (the sum of all cells in the table). The value of the test-statistic is

$${X}^{2} = {\sum }_{i = 1}^{r} {\sum }_{j = 1}^{c} \frac{{( {O}_{i , j} - {E}_{i , j} )}^{2}}{{E}_{i , j}} .$$

Fitting the model of “independence” reduces the number of degrees of freedom by p=r+c−1. The number of degrees of freedom is equal to the number of cells rc, minus the reduction in degrees of freedom, p, which reduces to (r−1)(c−1).

Second Step: Test of Dependence Between the Explanatory Variables and Choose the Most Significant Variables that are not Dependent Between them

The process works like this:

1. Variables that meet the significant criterion (0.05 usually) are arranged according to the Pearson's chi-squared test from the higher to the lower.

2. The Variable with the highest chi-squared value is selected

3. The following variable to be chosen is the variable that has not significant correlation with the variables already chosen. For the significance test we use again the Pearson's chi-squared test between the couple of explanatory variables to be examined.

Third Step: Top N Significant Uncorrelated Variables are Chosen to the Model.

Usually the model used the top 20 (a configuration parameter) significant uncorrelated variables (significant correlated with the target but uncorrelated among them).

This constrain on the number of the variables to be used in the model come to reduce the over fitting problem that can arise from the use of too many explanatory variables.

Automatic Categorization of Discrete Variables

As part of the variable selection process the system's engine can perform an automatic categorization of discrete variables with many values. The variables that can be categorized are marked so that the engine knows which variables to discretize.

The algorithm used for categorization groups values of the variable with similar percentage of the target.

Automatic Categorization of Continuous Variables

As part of the variable selection process the system's engine can perform an automatic categorization of continuous variables. All the continuous variables that can be used for modeling are categorized before entering the variable selection process.

The algorithm used for the categorization is the following:
1. Each customer in the sample is given a weight according to the target value so that the sample represents the all population
2. The algorithm creates up to 5 categories in the following way:
   2.1 The null or missing values represent a category of their own
   2.2 The other values are divided to up to 4 categories so that the sum of the weights is similar
   2.3 The records with the same value are in the same category
3. The result of the categorization is the range of each category so that any record (in the sample or in the score population) can receive the category value it belongs.

Modeling Process and Model Estimation

The modeling process runs on R, a statistical analysis package and based on Logistic Regression (also called a logit model) using the GLM procedure with the options of binomial family and Logit link function.

The explanatory variables in the model are the top N (a configuration parameter) variables that pass the previous step of variable selection. The top variables are the most significant related variables that have no correlation between them.

All the variables are entered in the model as factors.

Since still can be variables that are not significant because of the interactions with the other variables we added another step of backward stepwise so that all the variables that will remain in the regression will be significant according to the P-value set as parameter (usually 5%).

The system runs the analysis of variance (ANOVA) procedure on the results of the regression to get the type III statistics.

The outputs of the Logistic Regression modeling process are:

1. overall statistics on the model (significance, deviance, AIC, Pseudo R square)

2. parameter estimation

In addition to that, the system calculates the following accuracy statistics and graphs on in sample, out of sample and out of time:

1. Gini's statistics

2. Lift statistics and charts

3. Capture response charts

These statistics are calculated taking in account the over sampling done during the sampling process. For each observation in the sample there is the sampling weight that is used to calculate the statistics to represent the whole population.

A Lift Chart graphically represents the improvement that a mining model provides when compared against a random guess, and measures the change in terms of a lift score. By comparing the lift scores for various portions of your data set and for different models, you can determine which model is best, and which percentage of the cases in the data set would benefit from applying the model's predictions.

With a lift chart, you can compare the accuracy of predictions for multiple models that have the same predictable attribute. You can also assess the accuracy of prediction either for a single outcome (a single value of the predictable attribute), or for all outcomes (all values of the specified attribute).

In a Multi-Segment Offer the comparison of the accuracy statistics and graphs for the parent-offer and for the combination of the sub-offers is added. On the same sample of the parent-offer the prediction is calculate using for each customer the formula from the model of the segment the customer belongs to. This allows to compare the two predictions and to calculate the statistics and graphs on the same sample.

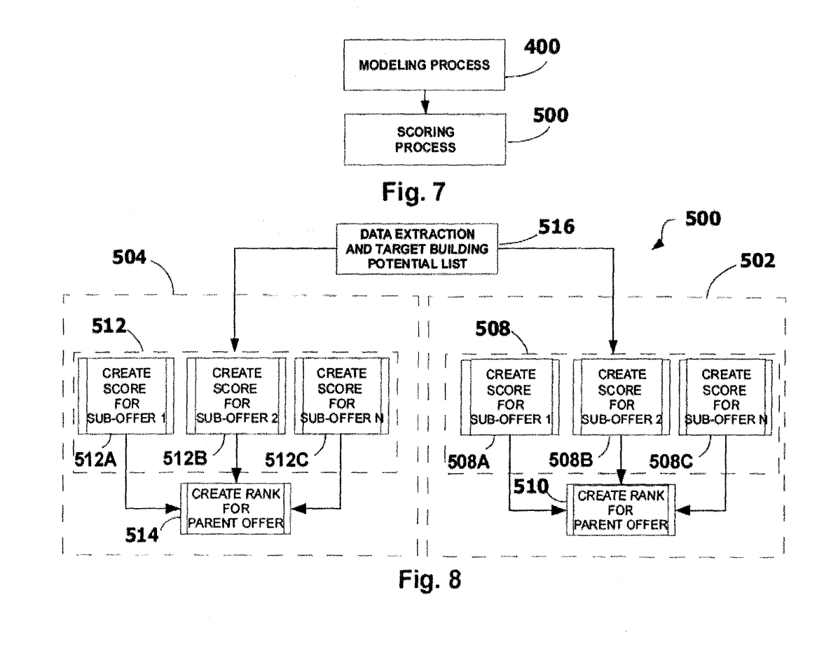

After processing the models 98 and 400, for predicting propensity or the amount/income per each product, by segments, and scores the customers in the sample for reviewing the models' fitness. Referring to FIGS. 7-8, there is another phase in which scoring process 500 score all the population, per each product. Each customer, from the customers extracted, is scored in steps 512,508 by the formula of the segment he belongs to. After all customers are scored, all scores are gathered in steps into one overall scores list which is sorted by the score and ranked 514 and 510 by percentiles.

### Scoring Process

The scoring process is automatic and includes the following steps:

1. Population extraction 516,100—extraction of the customers to be scored according to the conditions of the scoring population. The default in Population extraction 516 is that the conditions are the same as those used in the model (see data extraction section).

2. Data extraction 516,100—extraction of all the data needed for scoring according to the variables that entered the model.

3. Scoring—application of the formula built in the modeling process to the population and the data extracted. If we use a Multi-segment offer the score will be done only on the parent offer and each customer will get the score according to the formula of the model built on the segment he belongs.

4. Ranking—build rank and percentiles for each offer.

### Export Process

In the Export process the engine calculate other ranks and percentiles:

1. Rank of the model by Customer—Indicate the position of the model (product) for the customer according to the prediction from the scoring process (can be used for inbound campaigns, for example)

2. Percentile by Product—similar to the percentile for the offer, but it groups all the scores for the same product that comes from different models.

### Allocation Process

This process is run only with the Coupons module recommendations.

The engine relates the coupons (promotions) with the offers—could be more than one offer for each coupon.

This process does an optimal distribution of the coupons to the customers according to constraints.

The constraints can be:

1. Number of coupons to be distributed to each customers—in total and by Cross-sell/Up-sell

2. Number of coupons to be distributed in overall for each coupon: maximum and minimum.

3. Maximal budget for each vendor

4. Relations between the coupons—for example, can/can't be more than one coupon of the same category of products.

Under all of these constraints the algorithm finds the optimal distribution that gives the best coupons to each customer (according to the score from the model) and the best customers to each coupon.

### Automatic Multi Segment Modeling Technique

The multi segment modeling technique is a new technique for model building.

The statistical idea behind this technique is the following:

Let's say that we have a segmentation variable S with K segments Sₖ where k=1 . . . K.

In the normal approach we will have a logistic regression in this way:

logit(pᵢ)=β₀+β₁S₁ᵢ+ . . . +β_{K}S_{Ki}+βXᵢ+εᵢ

Where X is a matrix of explanatory variables (x₁ . . . x_{M}), X∈Xall (all the possible explanatory variables) and εi˜(0, σ²)

With the Multi Segment approach we will build K regressions:

logit(pᵢ)=β₀ₖ+βₖXₖᵢ+εₖᵢ

where Xₖ is a matrix of explanatory variables (x₁ . . . x_{kM}), Xₖ∈Xall and εᵢₖ˜N(0, σₖ²)

The advantages of the Multi Segment approach are that the explanatory variables can be different for each segment, the parameters can be different and also the residual variance can be different among segments.

In the case there are many observations and we are not afraid of the number of degree of freedoms of all the models together, this approach can bring to better results because can give to each segment its regression instead of an overall regression.

In the automatic multi segment modeling technique we apply a process that automatically creates the segment where for each one we will create a model.

The steps are the following:

1. Data extraction and Target building—according to the activity chosen and the target population the population is extract and the target is built

2. Sampling—The sampling process creates one sample. Since usually the target variable is rare we use the oversampling method that includes in the sample all the learning observations and a sample of the potential observation.

3. Decision tree model building—On the sample data a decision tree is built with the variables from the customer profile that are available for this step. The main parameters used in the decision tree are the following:

3.1 The minimum number of observations in any terminal leaf

3.2 The maximum number of leafs

3.3 The complexity parameter. Any split that does not decrease the overall lack of fit by a factor of cp is not attempted.

The result of the decision tree is the creation of a segment to be used further.

4. Offer Creation—for each leaf in the decision tree (or each value in the segment) an offer is created (sub offers of the parent offer).

5. Model building—for each leaf in the decision tree (or each value in the segment) either a model or an alternative prediction is created.

6. Accuracy statistics and graphs—For each model and for the parent offer the comparison of the accuracy statistics and graphs are created. For the parent offer we calculate also the statistics for the combination of the sub-offers. On the same sample of the parent offer we calculate the prediction using for each customer the formula from the model of the segment the customer belongs to. This allows us to compare the two predictions and to calculate the statistics and graphs on the same sample.

### BENEFITS OF THE PRESENT INVENTION

Customer retention is the activity that a selling organization undertakes in order to reduce customer defections. Successful customer retention starts with the first contact an organization has with a customer and continues throughout the entire lifetime of a relationship. Customer attrition, also known as customer churn, customer turnover, or customer defection, is the loss of clients or customers. Banks, telephone service companies, Internet service providers, pay TV companies, insurance firms, and alarm monitoring services, often use customer attrition analysis and customer attrition rates as one of their key business metrics (along with cash flow, EBITDA, etc.) because the cost of retaining an existing customer is far less than acquiring a new one. Companies from these sectors often have customer service branches which attempt to win back defecting clients, because recovered long-term customers can be worth much more to a company than newly recruited clients.

In some embodiments of the present invention the invention can be used as Customers Retenetion Optimization tool (CRO) which is automated data mining software for churn prediction and optimal reward recommendations. The CRO enables companies in various verticals to face their churn prediction and retention challenges by using a powerful, automated data-mining application which helps Retention divisions' analysts with no statistical know-how to: Automatically develop and deploy several churn prediction models to different segments-churn events. Automatically develop and deploy several models for recommending on the right retention offer that will retain the customer and increase its life time value (LTV)

In marketing, user lifetime value (LTV) is a prediction of the net profit attributed to the entire future relationship with a customer. The prediction model can have varying levels of sophistication and accuracy, ranging from a crude heuristic to the use of complex predictive analytics techniques.

The CRO enables organization to build and deploy a larger number of churn prediction and customer retention models, while using less resources, and thus significantly improving the efficiency of the targeted retention and preventing revenue loss of millions of dollars each year.

The CRO compared to classic data mining tools are: the CRO provides business solution for churn prediction and retention offers recommendations—as opposed to a data mining R&D environment that all data mining vendors provide and require professional services of statisticians and business intelligence (BI) experts for data management and modeling. The CRO in accordance with some embodiments of the present invention also dramatically decrease the time required for development of churn prediction models—from months to hours and even less time, while still getting the same lifts like manually developed models by statisticians. The CRO in accordance with some embodiments of the present invention also cuts to zero deployment time of churn prediction models—from months of work of SQL or ETL experts to an automatic deployment process. The CRO tool decreases the costs of models' development and deployment, from thousands of dollars to less than one hundred dollars. The CRO tool develops more models using the same analytical resources—develop and deploy churn prediction models for specific products, services or different kinds of churn events. The CRO tool updates the models more frequently adjusting the model to a changing business environment.

In some embodiments of the present invention the invention can be used for Next Best Offer (NBO) computerized tool for automatic personalized recommendation on the right products and services for each customer, or Customers Segmentation Analyzer (CSA) for automatic Lifetime Value calculation and customers' segmentation. By that, a company can achieve an integrated one-stop-shop for customers' business analytics models.

The system and method of the present invention is adapted to integrate easily with common data warehouse (DWH) and Campaign Management systems providing clear, measurable Return on Investment (ROI) in months.

The NBO enables companies' Marketing analyst with no statistical know how, to face their cross/up-sell and personalized recommendations challenges by using a powerful, automated data-mining application which helps to: Identify high potential customers for every product (or service) sold by the company, based on automatic data mining processes for customers behavior analysis. The automated data-mining application which helps to identifying the Next Best Offers/Actions for each customer, out of possibly hundreds and thousands of products/Actions sold/offered by the company.

The NBO is easily adapted to integrate into the company's Marketing IT systems (DWH, CRM, Campaign Management) and automatically manages and operates hundreds of data-mining models to match each of the customers with relevant products/services. The solution then optimizes and prioritizes the different propositions to identify the next best offer for each customer. The NBO enables organizations to create and deploy a significant larger number of Cross/Up-Sell models, and recommend the next best offer for each customer, while using fewer resources, and thus significantly increasing the outbound and inbound response rates and the organization revenues. The NBO automatically performs all complex ETL and statistical processes, Sampling, Data extraction & data management, Modeling, Validation, Scoring, and Deployment.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

1. A computer-readable medium comprising computer readable code for predicting customer behavior regarding to at least one offer, the computer-readable medium comprising:
a computer-readable code adapted to, obtain a set of population data extracted from at least one database of population group and target building potential list;
a computer-readable code adapted to, create a sampling process said sampling process samples said population data set and creates sample of said potential list;
a computer-readable code adapted to, automatically create and execute a segmentation model to partitioned said sample from said population data set to segments;
a computer-readable code adapted to, automatically generate sub-offers for each of said segments;
a computer-readable code adapted to, automatically create and execute statistical behavior model for each of said sub-offer;
a computer-readable code adapted to, combine results and statistical formulas of said sub-offer behavior models;
a computer-readable code adapted to, automatically create a model for parent-offer obtained from the combine results and formulas of said behavior models wherein, said parent model provides score prediction and statistical measures for each customer in the sample according to the model of said sub_offer of the segment that said customer belongs to; and
a computer-readable code adapted to, automatically create a scoring process for all of said data population set,
whereby, after all customers are scored, all scores are gathered into one overall scores list which is sorted by a score and ranked module by percentiles.

2. A computer-readable medium according to claim 1 wherein said sampling process creates three samples:
In-sample—to be used for modeling
Out-of-sample—to be used for validation on the same periods used in modeling
Out-of-time—to be used for validation on the last period of the customer profile, period that it is not used in modeling.

3. A computer-readable medium according to claim 1 wherein said segmentation model statistical model is of a decision trees model.

4. A computer-readable medium according to claim 1 wherein said sub-offer statistical model obtained from Logistic Regression Variable Selection Methods.

5. A computer-readable medium according to claim 1 wherein said parent-offer statistical model obtained from Logistic Regression Variable Selection Methods.

6. A computer-readable medium according to claim 4 wherein said statistical behavior model for each of said sub-offer comprising the steps of data extraction and target building potential list for each of said segment;
sampling creation and sampling potential list for each segment in said population group;
variable categorization for each said sample of each said segment;
variable selection for each said sample of each said segment;
modeling estimation of each of said segments;
building lift charts and statistical measures.

7. A computer-readable medium according to claim 5 wherein said statistical behavior model for parent-offer comprising the steps of data extraction and target building potential list for each of said segment;
sampling creation and sampling potential list for each segment in said population group;
variable categorization for each said sample of each said segment;
variable selection for each of said sample of each said segment;
modeling estimation of each of said segments;
scoring each customer in the sample with said sub-offer statistical formula;
building lift charts and statistical measures.

8. A computer-readable medium according to claim 1 comprising computer readable code wherein said code further comprising estimation module for estimating the amount of a product purchase and/or the income from the sale of said product.

9. A method for automatically predicting customer behavior regarding to at least one offer, said method comprising:
obtaining a set of population data extracted from at least one database of population group and target building potential list;
creating a sampling process said sampling process samples said population data set and creates sample of said potential list;
creating and executing a segmentation model to find segments in said sample of said population data;
generating sub-offers for each of said segments;
creating and executing statistical behavior model for each of said sub-offer;
combining results and statistical formulas of said sub-offer behavior models;
creating a model for parent-offer obtained from the combine results and formulas of said behavior models wherein, said parent model provides score prediction and statistical measures for each customer in the sample according to the model of said sub_offer of the segment that said customer belongs to; and
creating a scoring process for all of said data population set, whereby, after all customers are scored, all scores are gathered into one overall scores list which is sorted by a score and ranked module by percentiles.

10. The method of claim 9 wherein, said sampling process creates three samples:
In-sample—to be used for modeling
Out-of-sample—to be used for validation on the same periods used in modeling
Out-of-time—to be used for validation on the last period of the customer profile, period that it is not used in modeling.

11. The method of claim 9 wherein, said segmentation model statistical model is of a decision trees model.

12. The method of claim 9 wherein, said sub-offer statistical model obtained from Logistic Regression Variable Selection Methods.

13. The method of claim 9 wherein said parent-offer statistical model obtained from Logistic Regression Variable Selection Methods.

14. The method of claim 12 wherein said statistical behavior model for each of said sub-offer comprising the steps of data extraction and target building potential list for each of said segment;
sampling creation and sampling potential list for each segment in said population group;
variable categorization for each said sample of each said segment;
variable selection for each said sample of each said segment;
modeling estimation of each of said segments;
building lift charts and statistical measures.

15. The method of claim 13 wherein said statistical behavior model for parent-offer comprising the steps of data extraction and target building potential list for each of said segment;
sampling creation and sampling potential list for each segment in said population group;
variable categorization for each said sample of each said segment;
variable selection for each of said sample of each said segment;
modeling estimation of each of said segments;
scoring each customer in the sample with said sub-offer statistical formula;
and building lift charts and statistical measures.

16. The method of claim 9, wherein said method further comprising wherein estimating the amount of a product purchase and/or the income from the sale of said product.

17. A system for predicting customer behavior regarding to at least one offer, comprising:
A database for storing database of population groups;
A data extracted module for obtaining a set of population data extracted from at least one of said groups stored in said database and target building potential list;
a sampling processing module for sampling samples from said extracted population data set and creates sample of said potential list;
a segmentation module for creating and executing a segmentation model to partitioned said sample from said population data set to segments;
a sub-offer modules for generating sub-offers for each of said segments;
a behavior module for creating and executing statistical behavior model for each of said sub-offer;
a module for combining results and statistical formulas of said sub-offer behavior models;
a parent-offer module for creating and executing a model for parent-offer obtained from the combine results and formulas of said behavior models wherein, said parent model module provides score prediction and statistical measures for each customer in the sample according to the model of said sub_offer of the segment that said customer belongs to; and
scoring and ranking module for creating a scoring process for all of said data population set,
whereby, after all customers are scored, all scores are gathered into one overall scores list which is sorted by said score and ranked module by percentiles.
